(19) United States
(12) Patent Application Publication
(10) Pub. No.: US 2012/0316006 A1
(43) Pub. Date: Dec. 13, 2012

(54) GOLF CLUB, METHOD FOR ADJUSTING CHARACTERISTICS THEREOF AND METHOD FOR PRODUCING GOLF CLUBHEAD

(75) Inventors: Tomonori KITAGAWA, Tokyo (JP); Fumiaki SATO, Saitama (JP)

(73) Assignee: BRIDGESTONE SPORTS CO., LTD., Tokyo (JP)

(21) Appl. No.: 13/494,187

(22) Filed: Jun. 12, 2012

(30) Foreign Application Priority Data
Jun. 13, 2011 (JP) 2011-131437

(51) Int. Cl. A63B 53/02; B23P 17/00; A63B 53/00

(52) U.S. Cl. 473/307; 473/409; 29/426.2

(57) ABSTRACT

A golf club includes: a partition plate portion provided within a hosel column; a spline ring in which a spline is provided on an inner circumferential surface of an inner hole being interposed between a distal end portion of a shaft case and the partition plate portion; the spline ring welded to the shaft case; a projecting shaft portion provided at a distal end of the shaft case; a spline provided on an outer circumferential surface of the projecting shaft portion; wherein: the projecting shaft portion is inserted into the inner hole; the spline of the projecting shaft portion and the spline of the spline ring are in engagement with each other; and a bolt which is inserted through a bolt passage hole provided in the partition plate portion from a sole side of the clubhead is screwed into the shaft case.

### BACKGROUND

1. Field of the Invention

The present invention relates to a golf club and more particularly to a golf club which can facilitate the adjustment of characteristics thereof such as lie angle, slice angle and progression. Additionally, the invention relates to a method for adjusting the characteristics of the golf club and a method for producing a golf clubhead.

2. Description of the Related Art

A golf club is such that a clubhead is attached to a distal end portion of a shaft. A grip is mounted at a proximal end portion of the shaft.

In a conventional general clubhead for a golf club, a hosel hole is provided directly in the clubhead, and a shaft fits in the hosel hole to be secured in place therein with an adhesive. In general, an epoxy system adhesive is used as the adhesive. When the shaft is replaced with another shaft, the hosel portion of the clubhead of the shaft to be replaced is heated to break the cured structure of epoxy resin, whereby the shaft can be pulled out of the hosel hole.

With the conventional clubhead for a golf club, some labor hours have to be taken for replacement of shafts. Additionally, characteristics such as lie angle, slice angle and progression cannot be adjusted.

JP-A-2011-4801 describes a golf club which can not only facilitate the replacement of shafts but also enable the adjustment of characteristics thereof such as lie angle, slice angle and progression and a method for adjusting the characteristics. A clubhead of the golf club described in JP-A-2011-4801 is a clubhead including a hosel insertion hole into which a distal end of a shaft fits, comprising a female screw thread formed on an inner circumferential surface of an entrance portion of the hosel insertion hole, a hosel having a shaft case insertion hole and detachably mounted in a deep portion of the hosel insertion hole, a shaft case having a shaft insertion hole and detachably mounted in the shaft case insertion hole at a distal end portion thereof, a ring holder fitted on the shaft case and capable of moving an axial direction, and a screw member fitted on the ring holder so as to rotate in a circumferential direction and capable of moving in the axial direction, wherein a male screw thread provided on an outer circumferential surface of the screw member engages with the female screw thread.

In the golf club of JP-A-2011-4801, the shaft case can be fixed in place or pulled out of the hosel mounting hole by screwing or unscrewing the screw member to or from the female screw thread. Then, the hosel and the ring holder are replaced with a hosel and a ring holder which have a different lie angle, slice angle or progression, or the circumferential phase of the holder is changed, so that the shaft case with the shaft is mounted again in a main body of the clubhead main via the hosel.

For example, by replacing the hosel and the ring holder with a hosel and a ring holder which change the axis of the shaft so that the axis of the shaft is inclined relative to the axis of the hosel insertion hole (for example, in a direction in which the axis of the shaft intersects the axis of the hosel insertion hole obliquely), the mounting direction of the shaft on the clubhead main body is changed, whereby the lie angle and the slice angle are also changed.

Consequently, in the golf club which includes the same shaft and the same clubhead main body, only the lie angle and the slice angle can be adjusted.

Additionally, by replacing the hosel and the ring holder with the hosel and the ring holder which produce the state in which the position of the axis of the shaft case insertion hole is offset in parallel from the position of the axis of the hosel insertion hole, the progression or the distance from the shaft to the center of gravity of the clubhead main body (the center of gravity distance) can be adjusted in the golf club having the same shaft and the same clubhead main body.

Further, in the golf club according to JP-A-2011-4801, shafts can be replaced by replacing shaft cases which each hold a shaft with the hosel and the ring holder staying unchanged. Namely, shaft cases of the same type are prepared as those to be installed in the hosel. Then, shafts having different playing characteristics are securely assembled to the shaft cases so prepared to form shaft case/shaft assemblies, so that the shaft case/shaft assembly which is mounted in the hosel in the clubhead main body is replaced with one of the shaft case/shaft assemblies, thereby making it possible to obtain a golf club which has a different shaft only.

JP-A-6-142236 describes a golf club in which a shaft mounting pipe is welded to a clubhead main body shell and a foamed urethane injection hole is provided in the shaft mounting pipe. This injection hole is used only for such an application in which a foamed urethane is injected into the clubhead.

In the golf club described in JP-A-2011-4801, the ring holder which fits on the shaft case and the screw member which fits, in turn, on the ring holder are necessary, resulting in a slightly high parts cost.

### SUMMARY

An object of the invention is to provide a golf club which can not only facilitate the replacement of shafts but also adjust the characteristics of the golf club such as lie angle, slice angle or progression and which can be produced at low cost, a method for adjusting the characteristics of the golf club and a method for producing a clubhead of the golf club.

According to a first aspect of the invention, there is provided a golf club which has a clubhead attached to a distal end of a shaft and in which a substantially cylindrical shaft case is secured to the distal end of the shaft, the shaft case is inserted into a hosel column of the clubhead, and the shaft case is fixed in place in the hosel column, wherein a partition plate portion is provided within the hosel column, wherein a spline ring in which a spline is provided on an inner circumferential surface of an inner hole is interposed between a distal end portion of the shaft case and the partition plate portion, wherein the spline ring is welded to the shaft case, wherein a projecting shaft portion is provided at a distal end of the shaft case, wherein a spline is provided on an outer circumferential surface of the projecting shaft portion, wherein the projecting shaft portion is inserted into the inner hole of the spline ring, wherein the spline of the projecting shaft portion and the spline of the spline ring are in engagement with each other, and wherein a bolt which is inserted through a bolt passage hole provided in the partition plate portion from a sole side of the clubhead is screwed into the shaft case, whereby the shaft case is fixed in place in the hosel column.

According to a second aspect of the invention, there is provided a golf club as set forth in the first aspect, wherein a female or internally threaded hole is provided in a distal end face of the projecting shaft portion, so that the bolt is screwed into the internally threaded hole.

According to a third aspect of the invention, there is provided a golf club as set forth in the first or second aspect, wherein an axis of the shaft is inclined relative to an axis of the cylindrical portion.

According to a forth aspect of the invention, there is provided a golf club as set forth in the first or second, wherein an axis of the shaft and an axis of the cylindrical portion are parallel to each other.

According to a fifth aspect of the invention, there is provided a method for adjusting characteristics of the golf club set forth in any of the first to fourth aspects, comprising removing the bolt so as to separate the projecting shaft portion of the shaft case from the spline ring, rotating the shaft case so as to change the position of the shaft passage hole or the inclination of the shaft, thereafter bringing the projecting shaft portion of the shaft case into engagement with the spline ring again, and fixing the shaft case with the bolt.

According to a sixth aspect of the invention, there is provided a method for adjusting characteristics of the golf club set forth in any of the first to fourth aspects by replacing the shaft with a different shaft, comprising preparing a different shaft case and shaft assembly in advance by securing a different shaft to a different shaft case, removing a shaft case and shaft assembly mounted in the golf club from the clubhead, and mounting the different shaft case and shaft assembly so prepared in the clubhead.

According to a seventh aspect of the invention, there is provided a method for producing a golf club having the steps of disposing the spline ring in the hosel column of the clubhead of the golf club set forth in any of the first to fourth aspects and then welding the spline ring to the hosel column, the method comprising providing a hole in a side circumferential surface of the hosel column, holding the spline ring at the distal end of the shaft case, inserting the spline ring and the shaft case within the hosel column, welding the spline ring and the hosel column together via the hole, and thereafter removing the shaft case from the hosel column.

A method for producing a golf club according to an eighth aspect of the invention is a method for producing a golf club in which in the method set forth in the seventh aspect, a jig having a distal end portion which is of the same shape as the shaft case is used in place of the shaft case. Namely, according to the eight aspect of the invention, there is provided a method for producing a golf club having the steps of disposing the spline ring in the hosel column of the clubhead of the golf club set forth in any of the first to fourth aspects and then welding the spline ring to the hosel column, the method comprising providing a hole in a side circumferential surface of the hosel column, holding the spline ring at a distal end portion of a jig which is of the same shape as the shaft case, inserting the spline ring and the jig within the hosel column, welding the spline ring and the hosel column together via the hole, and thereafter removing the jig from the hosel column.

According to a ninth aspect of the invention, there is provided a method for producing a golf club as set forth in the seventh or eighth aspect, comprising making up the clubhead from a clubhead main body having the hosel column and an open portion which facilitates welding work and a closure part which closes the open portion, and integrating the closure part into the clubhead main body after the welding work of the spline ring.

According to a tenth aspect of the invention, there is provided a method for producing a golf club as set forth in the ninth aspect, wherein a plurality of holes like the hole are provided, and open portions like the open portion are present in a crown portion and a face portion of the clubhead of the golf club.

In the golf club of the invention, the shaft case is inserted into the hosel column, and the shaft case is fixed in place by the bolt which is inserted from the sole side. Therefore, the ring holder and the annular screw member of JP-A-2011-4801 are unnecessary, resulting in the low production cost.

In the golf club of the invention, the spline ring is interposed between the partition plate portion provided within the hosel column and the distal end portion of the shaft case, and the spline ring is welded to the hosel column. Additionally, the spline on the projecting shaft portion at the distal end portion of the shaft case and the spline on the inner hole in the spline ring are in engagement with each other, and therefore, the shaft case is positioned with respect to the circumferential direction.

In the golf club of the invention, when the bolt is loosened to be removed, the projecting shaft portion of the shaft case can be removed from the spline ring and is then turned in the circumferential direction to change the orientation (the circumferential phase) thereof. Consequently, for example, when a shaft case is used in which the axis of a shaft is inclined obliquely relative to the axis of a shaft case insertion hole, the mounting direction of the shaft on the clubhead main body is changed by changing the circumferential phase of the shaft case, whereby the lie angle or the slice angle are changed. By so doing, only the lie angle or the slice angle can be adjusted in the golf club having completely the same shaft and the same clubhead main body.

Additionally, when a shaft case is used which has a configuration in which the position of the axis of a shaft case insertion hole is offset in parallel from the position of the axis of a hosel insertion hole, by changing the circumferential phase of the shaft case, the progression or the distance from the shaft to the center of gravity of the clubhead (the center of gravity distance) can be adjusted in the golf club having completely the same shaft and the same clubhead main body.

In this invention, shaft cases of completely the same shape are prepared as shaft cases to be mounted in the hosel. Then, shafts having different playing characteristics are secured individually to the shaft cases so as to prepare shaft case and shaft assemblies. Then, a shaft case and shaft assembly which is mounted in the clubhead is replaced with one of the shaft case and shaft assemblies so prepared, whereby golf clubs can be obtained which have the different shafts.

In this way, according to the invention, the labor hours and time can be eliminated which have to be spent doing the troublesome work of breaking the structure of the adhesive by heating the hosel portion of the clubhead and mounting the different shaft to be fixed in place with the adhesive in the related art golf clubs. Because of this, in the golf club that has just been used to make a test shot, the lie angle, the slice angle, the progression or the center of gravity distance can be changed quickly for another immediate test shot. Additionally, the shaft case and shaft assembly of the golf club that has just been used to make a test shot is removed from the clubhead of the golf club, and then the different shaft case and shaft assembly having the different shaft characteristics is mounted in the clubhead for another immediate test shot. In this way, a golfer can find out a golf club which is suited to him or her very easily in a golf club shop. In addition, shafts can be evaluated without considering the production tolerance of clubheads.

In recent years, systems have been developed which help golfers find out a golf club which best matches them by using a computer and a high-speed camera when they attempt to find out a golf club which matches their skill. In these systems, a golfer test plays commercially marketed golf clubs for comparison based on head speed and launch angle to find out a golf club which best matches him or her.

In contrast to this, according to the invention, the golfer test plays a golf club having the same shaft and clubhead by changing lie angle, slice angle, center of gravity distance and progression and can feel easily in reality a sensation of difference in flight characteristics (launch angle and spins) of balls shot. Additionally, the golfer can feel in reality a sensation of different in shaft by test playing the golf club with the same clubhead and different shafts by replacing shafts only. In addition, depending upon the conditions of the golfer, the golfer can replace shafts or adjust the playing characteristics of the golf club such as lie angle, slice angle and progression, as well.

According to the method for producing a golf club according to the invention, the hose is provided in the hosel column in advance, and by making use of the hole so formed, the spline ring within the hosel column and the hosel column can be welded together.

To dispose the spline ring within the hosel column before the start of the welding work, the spline ring and the shaft case are inserted into the hosel column in such a state that the spline ring is mounted at the distal end of the shaft case. Since the splines of the shaft case and the spline ring are in engagement with each other, the spline ring is integrated into the shaft case. Because of this, by turning the shaft case so as to direct the orientation thereof (the circumferential phase thereof) in a specific direction, the orientation of the spline ring can be changed to the specific direction. Additionally, when the shaft case is fixed, it follows that the spline ring is also fixed. Then, the shaft case is fixed with the orientation of the shaft case directed in a specific direction, and the spline ring is welded to the hosel column, thereby making it possible to weld the spline ring to the hosel column with the spline ring oriented in the specific direction.

Additionally, by use of the jig having the distal end portion which is of the same shape of the shaft case in place of the shaft case, the welding work of the spline ring can be facilitated in a similar way. By making the jig longer than the shaft case, the fixing of the jig is facilitated.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a front view of a clubhead according to an embodiment of the invention.

FIG. 2 is a side view of a heel side of the clubhead.

FIG. 3 is a sectional view taken along the line in FIG. 1.

FIG. 4 is an exploded perspective view of the clubhead.

FIG. 5 is a perspective view showing an assembling method of a golf club.

FIG. 6 is a perspective view showing a production method of the clubhead of the golf club (a welding method of a spline ring).

FIG. 7 is a perspective view showing the production method of the clubhead of the golf club (the welding method of the spline ring).

FIG. 8 is a sectional view showing the embodiment.

FIGS. 9A to 9F show the configuration of a hosel column for use in the embodiment, in which FIG. 9A is a front perspective view, FIG. 9B is a front view, FIG. 9C is a sectional view taken along the line C-C in FIG. 9B, FIG. 9D is a view resulting when the hosel column is seen in a direction indicated by an arrow D in FIG. 9A, FIG. 9E is a view resulting when the hosel column is seen in a direction indicated by an arrow E in FIG. 9A, and FIG. 9F is a rear view of the hosel column.

FIG. 10 is a perspective view showing a production method of the clubhead.

FIG. 11 is a sectional view showing another embodiment.

### DETAILED DESCRIPTION OF THE INVENTION

Hereinafter, embodiments of the invention will be described by reference to the drawings.

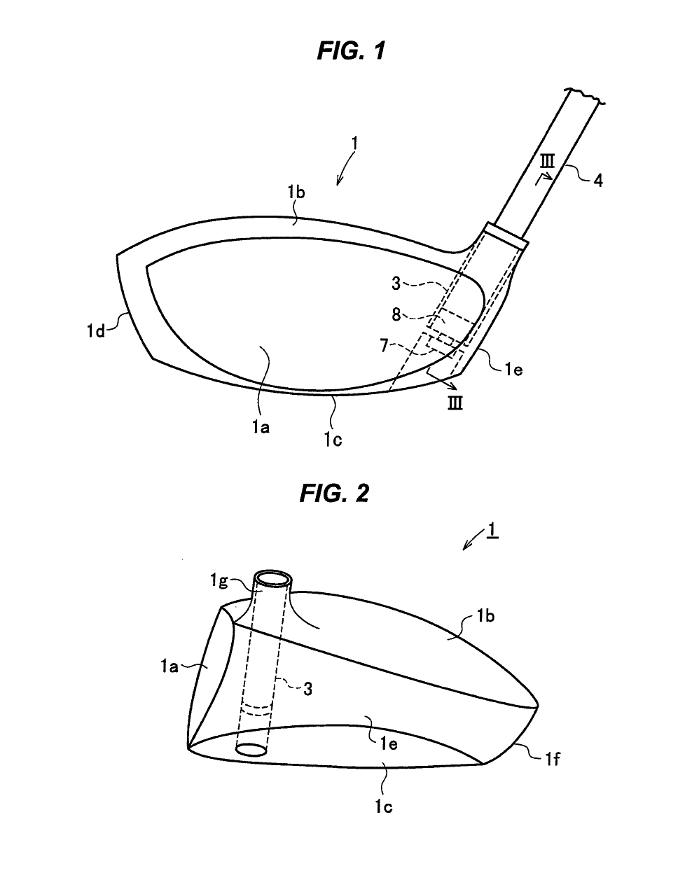

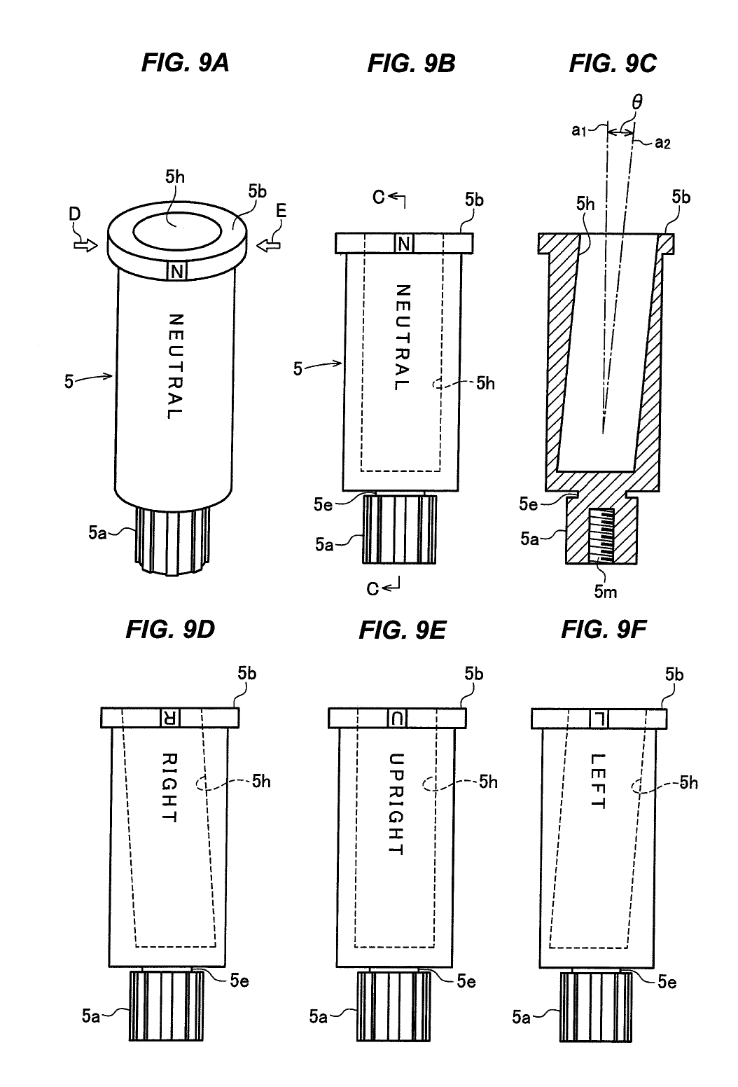

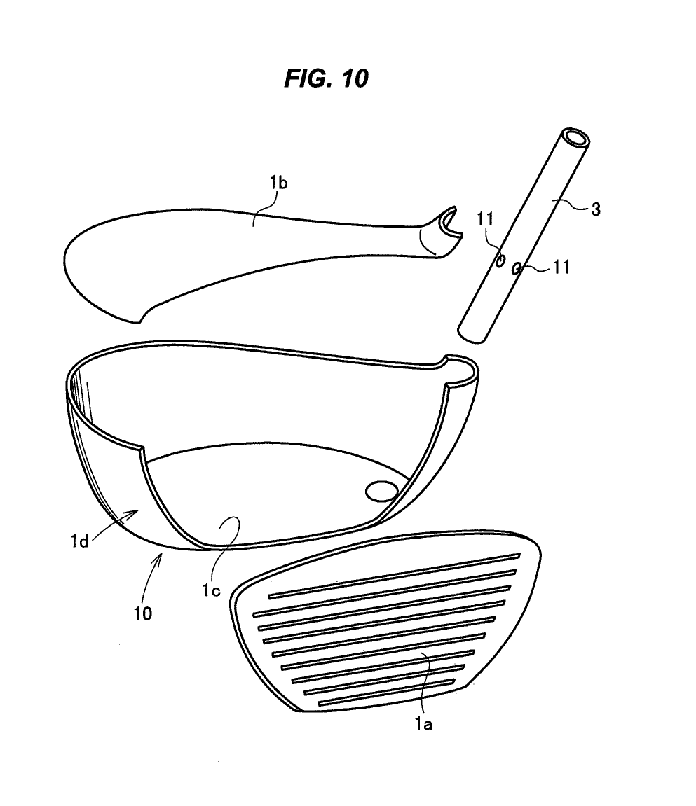

FIGS. 1 to 10 show a golf club according to a first embodiment of the invention. FIGS. 9A to 9F shows a hosel column in a larger diameter-to-length ration than in FIGS. 1 to 8 for the purpose of clearly showing the inclination of an inner hole in the hosel column.

In this golf club according to the first embodiment, a shaft 4 is mounted in a hosel column 3 in a clubhead 1 via a shaft case 5, a spline ring 8 and a bolt 7.

The clubhead 1 is of a wood type and is hollow. The clubhead 1 has a face portion 1a, a crown portion 1b, a sole portion 1c, a toe portion 1d, a heel portion 1e, a back portion if and a hosel portion 1g.

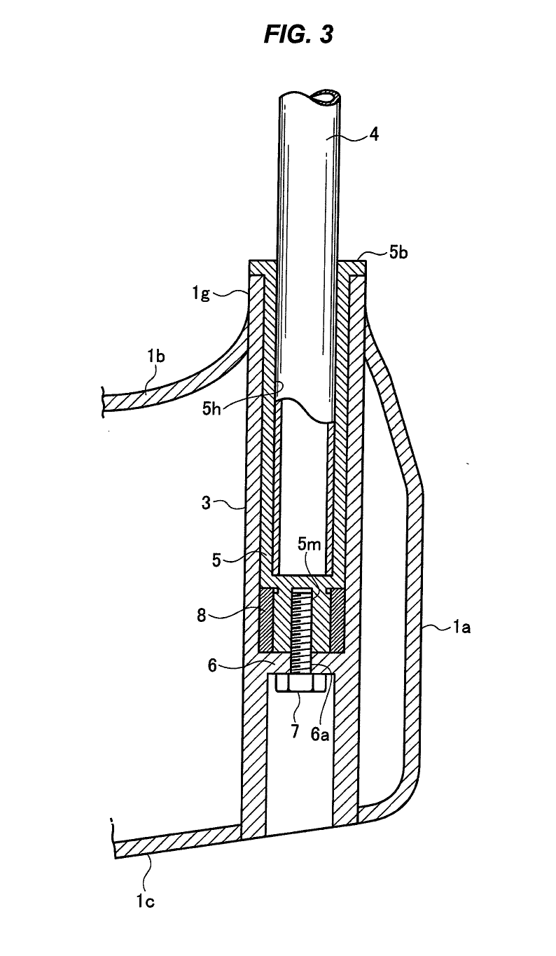

As shown in FIG. 3, the hosel portion 1g is provided on a face portion 1a side and at a heel portion 1e end and the crown portion 1b. The hosel column 3 is continuous with the hosel portion 1g and extends as far as the sole portion 1c. The hosel column 3 has a shape like a cylindrical pipe, and a partition plate portion 6 is provided in an inner hole in the hosel column 3 at an intermediate portion along a length in a longitudinal direction (the direction of an axis) of the inner hole so as to be normal to the direction of the axis. The spline ring 8 is disposed on an upper side of the partition plate portion 6. The shaft case 5 is provided further upwards than the partition plate portion 6. The bolt 7 is inserted to be passed upwards through a bolt passage hole (an opening) 6a which is provided in the partition plate portion 6 from blow and is then screwed into a female or internally threaded hole 5m in the shaft case 5.

As shown in FIGS. 3 to 6 and 9A to 9F, the shaft case 5 is a cylindrical member having an outside diameter which is extremely slightly smaller than an inside diameter of the hosel column 3, and a shaft 4 insertion hole 5h is provided in the shaft case 5 so as to extend from an upper end to a lower end thereof. The shaft 4 is inserted into the shaft insertion hole 5h and is secured in place therein with an adhesive. The shaft insertion hole 5h has a depth of 10 mm or larger. The depth of the shaft insertion hole 5h is preferably in the range of 10 to 50 mm and is more preferably in the range of 20 to 40 mm. An outwardly oriented, collar-shaped flange portion 5b is provided at the upper end (a rear end) of the shaft case 5. The flange portion 5b is an annular plate and may be tapered so that the flange portion 5b decreases in diameter as it extends upwards. However, the flange portion 5b is not limited to that configuration.

A projecting shaft portion 5a is provided at a lower portion (a distal end portion) of the shaft case 5 so as to project therefrom. An axis of the projecting shaft portion 5a is common to an axis of an outer circumferential surface of the shaft case 5. Splines (elongated projections extending parallel to an axis or center line of the projecting shaft portion 5a) are provided on an outer circumferential surface of the projecting shaft portion 5a. Additionally, a groove 5e is provided along the full circumference of a root portion of the projecting shaft portion 5a.

The internally threaded hole 5m is provided so as to be depressed in the direction of the center line from a distal end face of the projecting shaft portion 5a.

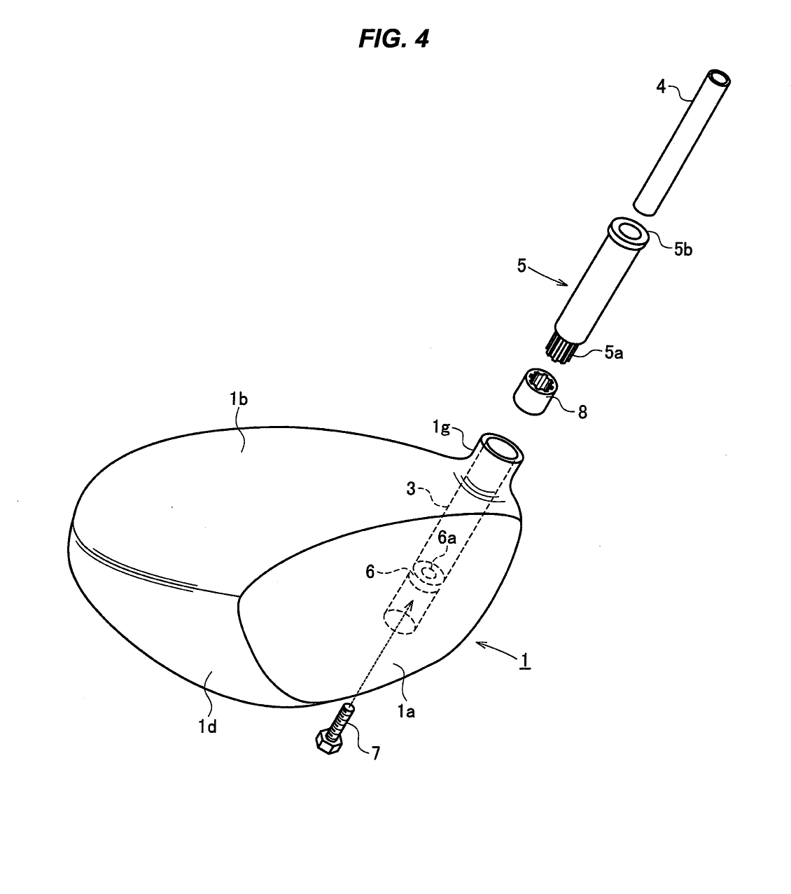

As shown in FIG. 4, the spline ring 8 is a ring having a cylindrical outer circumferential shape. Splines are formed on an inner circumferential surface of an inner hole which penetrates the spline ring 8 in an axial direction. The splines of the projecting shaft portion 5a are brought into engagement with the splines of the spline ring 8. In this embodiment, eight splines are provided so that a circumferential phase of the shaft case 5 can be changed at intervals of 45°. However, four splines may be provided so that the circumferential phase of the shaft case 5 can be changed at intervals of 90°. Alternatively, the number of splines may be set to 12, 16 or 20.

The spline ring 8 is inserted into the hosel column 3 and is then welded to the hosel column 3. A welding method used will be described later.

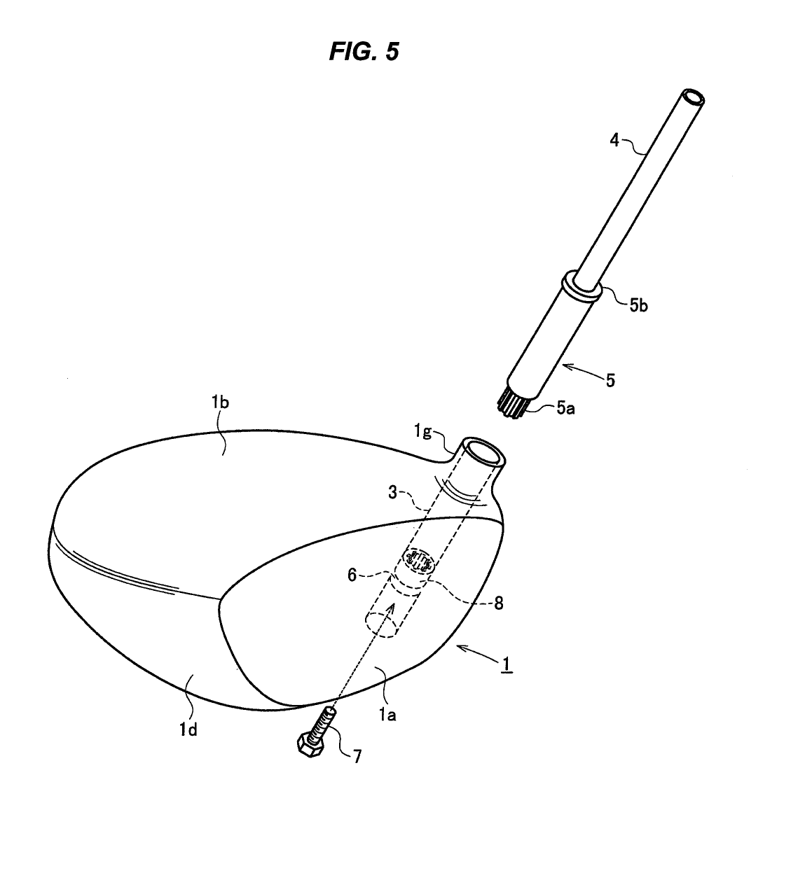

When building up the golf club, the spline ring 8 is disposed in a deep portion in the hosel column 3 and is then welded thereto in advance. Additionally, as shown in FIG. 5, the shaft case 5 is secured to a distal end of the shaft 4 by use of an adhesive so that a shaft case and shaft assembly is prepared. Preferably, the adhesive is applied to an outer circumferential surface of a distal end portion of the shaft 4 and the shaft 4 is inserted into a deepest portion of the shaft insertion hole 5h in the shaft case 5. An epoxy system adhesive is preferable as the adhesive.

As shown in FIG. 3, in this embodiment, the internally threaded hole 5m does not penetrate the shaft case 5. In this case, an air relief small hole may be provided which establishes a communication between the internally threaded hole 5m and the shaft insertion hole 5h so that air flows out through the internally threaded hole 5m when the shaft is inserted into the shaft insertion hole 5h in the shaft case 5.

The shaft case 5 of the shaft case and shaft assembly is inserted into the hosel column 3, the projecting shaft portion 5a of the shaft case 5 is inserted into the inner hole in the spline ring 8, and the splines on the projecting shaft portion 5a are brought into engagement with the splines in the spline ring 8. Following this, the bolt 7 is screwed into the internally threaded hole 5m via the bolt passage hole 6a.

By so doing, as shown in FIGS. 1, 3, the shaft case 5 is fixed in place in the clubhead 1. Since the shaft case 5 and the shaft 4 are bonded together rigidly and strongly by the adhesive, the golf club is completed in which the shaft 4 and the clubhead 1 are integrated into one unit. Since the splines of the shaft case 5 are in engagement with the splines of the spline ring 8, the circumferential phases of the shaft 4 and the shaft case 5 are determined accurately. Additionally, there is provided a high fixing rigidity in the direction of torque between the shaft 4 and the shaft case 5.

The spline ring 8 is an axially short annular member which is disposed only in a deep portion in the hosel column 3 and is small in weight.

In this invention, shafts can be replaced easily in this golf club. When replacing shafts in the gold club, a shaft case of the same type as the shaft case 5 is secured in advance to a different shaft which is to replace one in the golf club.

The bolt 7 is removed from the golf club, and the shaft 4 mounted in the clubhead 1 is removed from the clubhead 1 together with the shaft case 5 also mounted in the clubhead 1. Following this, the different shaft which is integral with the shaft case (the shaft case and shaft assembly) is inserted into the clubhead 1 and is fixed in place therein with the bolt 7.

In this way, the mounting and replacement of shafts can be performed extremely easily and quickly. In the related art golf clubs, when shafts are replaced, the hosel portion of the golf club is heated to break the structure of cured adhesive so that the existing shaft is removed from the hosel portion, and thereafter, the replacement shaft is secured in place in the clubhead with the adhesive. Thus, a period of time in the range of several hours to one day is taken for the replacement of shafts. However, in the embodiment of the invention, the shaft replacement can be brought about within about several minutes due to the shaft case 5 being attached to the replacement shaft with the adhesive in advance. Consequently, an approach can be realized in which shafts of various specifications which are attached to shaft cases are prepared in advance, and those different shafts are mounted sequentially one by one in the same clubhead 1 for test shots.

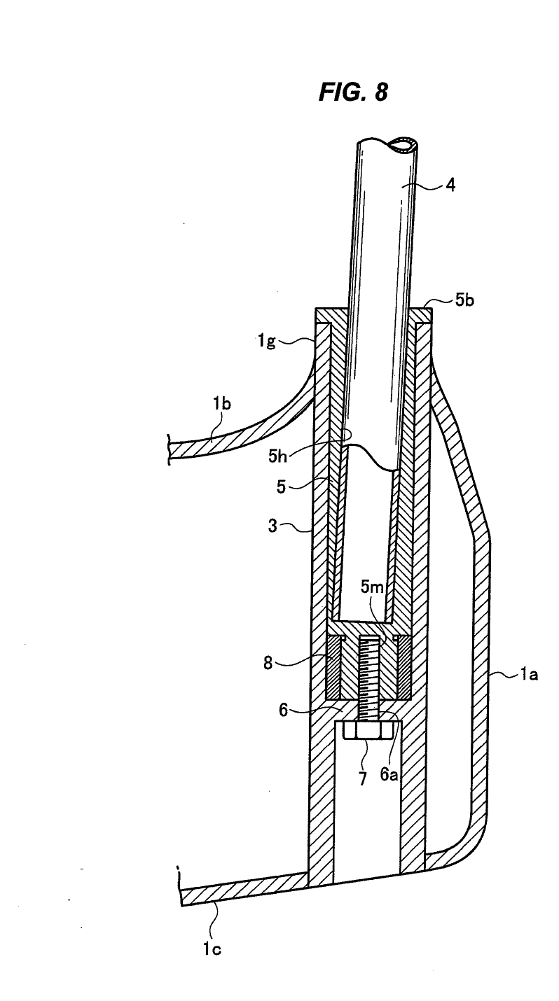

As shown in FIGS. 8 and 9A to 9F, in this embodiment, the axis of the shaft insertion hole 5h is inclined to the axis of the outer circumferential surface of the shaft case 5, that is, the axis of the hosel column 3, so that the inclination of the shaft 4 can be changed. Specifically, as shown in FIG. 9C, a center line a₁ of the outer circumferential surface of the shaft case 5 is made to intersect a center line a₂ of the shaft insertion hole 5h at an angle θ. In the normal case, this angle θ is in the range of 0.1 to 5° and is particularly preferably in the range of 0.25 to 3°.

The center lines may not intersect each other and may in a “twisted” relation. Namely, the center lines of the shaft insertion hole 5h and the hosel column 3 may be in such a relation in which the center lines of both the members do not intersect each other but one center line passes by the other center line.

As shown in FIG. 9A, a character “N” as a mark denoting a neutral position is written on to an outer circumferential surface of the flange portion 5b of the shaft case 5 in a position where a plane containing the center lines a₁, a₂ intersects the outer circumferential surface of the flange portion 5b and which lies opposite to the center line a₂ across the center line a₁. Additionally, a word reading “NEUTRAL” as a mark denoting the neutral position is written below the mark “N” (on a side facing the projecting shaft portion 5a). A mark “R” and a word reading “RIGHT” are written in a position lying 90° leftwards from the “N” and “NEUTRAL.” Additionally, a mark “L” and a word reading “LEFT” are written in a position lying 90° rightwards from the “N” and “NEUTRAL.” Further, a character “U” and a word reading “UPRIGHT” are written in a position lying 180° opposite to the “N” and “NEUTRAL.” Any of the marks or words reading NEUTRAL, RIGHT, LEFT and UPRIGHT extends in a parallel direction to the line of axis of the center shaft 5.

In FIGS. 1 to 3, the mark N and the word NEUTRAL on the shaft case 5 are oriented towards the toe portion of the clubhead 1. This state represents a standard state of the golf club.

In contrast to this, in FIG. 8, the shaft case 5 is turned 90° clockwise from the state shown in FIGS. 1 to 3 as viewed from the top, in which state, the mark L and the word LEFT are oriented towards the toe portion of the clubhead 1. Namely, a surface shown in FIG. 9E is oriented towards the toe portion of the clubhead 1. Because of this, in FIG. 8, the center line of the shaft 4 is inclined towards the face relative to the center line of the hosel column 3. The orientation of the shaft 4 can be changed by turning the shaft case 5 through 90° or 180° from the state shown in FIG. 8. Namely, the shaft 4 can be inclined towards the toe or back side of the clubhead 1.

In this way, the lie angle or slice angle can be changed by changing the inclination of the shaft 4.

To describe the change in lie angle, the lie angle becomes the smallest and the flattest when the shaft 4 is inclined towards the toe portion of the clubhead 1 by orienting the mark N and the word NEUTRAL towards the toe. An uppermost lie of the clubhead 1 is obtained when the mark U and the word UPRIGHT are oriented towards the toe portion or when a surface shown in FIG. 9E is oriented towards the toe portion of the clubhead 1.

To describe the change in slice angle, a state in which a surface (N, NEUTRAL) shown in FIG. 9B is oriented towards the toe portion of the clubhead 1 constitutes a standard state. A hook face in which the face of the clubhead 1 is closed most is obtained in FIG. 8 where the shaft 4 is inclined most towards the face side of the clubhead 1 by orienting the mark L and the word LEFT towards the toe portion of the clubhead 1. On the contrary to this, a slice face in which the face of the clubhead 1 is opened most is obtained by inclining the shaft 4 most towards the rear by orienting the mark R and the word RIGHT towards the toe portion of the clubhead 1.

In this way, the inclination direction of the shaft 4 relative to the clubhead 1 can be changed by use of the shaft case 5 shown in FIGS. 9A to 9F, thereby making it possible to change the lie angle and the slice angle. In the description above, although the orientation of the shaft case 5 is described as being changed every 90°, the orientation of the shaft case 5 may be changed every 45°. By adopting this configuration, an intermediate state between the states described above can be obtained. For example, the specification of the golf club can be adjusted finely to a “slight hook face,” a “slight slice face,” and a “slightly upper lie.”

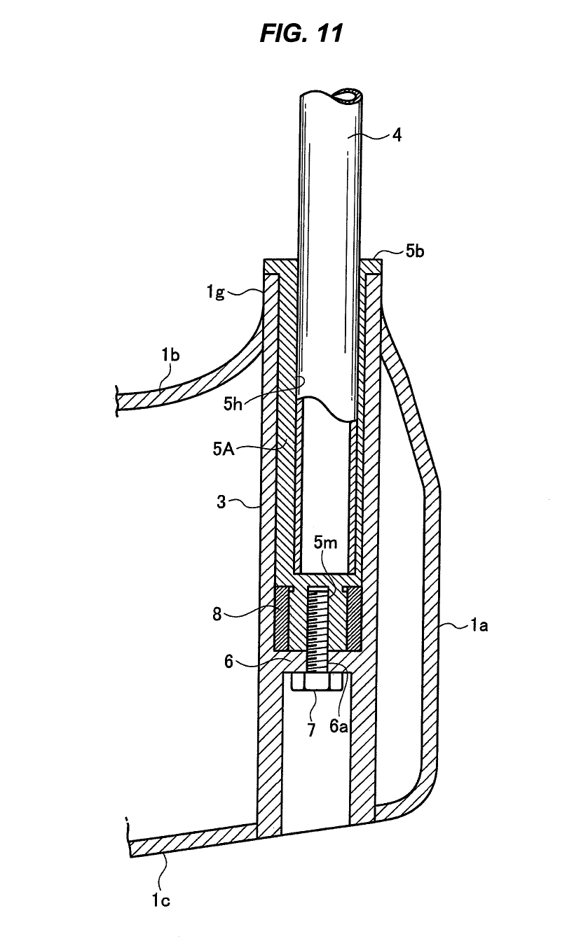

FIG. 11 shows a shaft case 5A in which a shaft insertion hole 5h is offset from the position of an axis of the shaft case 5. An axis of the shaft insertion hole 5h is parallel to an axis of an outer circumferential surface of the shaft case 5 and is slightly spaced apart therefrom (for example, 0.5 to 4 mm).

The progression of the shaft can be adjusted by use of the shaft case 5A. For example, as shown in FIG. 11, a shaft 4 can be positioned closer by the offset distance to a face side a clubhead than in FIG. 3.

A bolt 7 is removed from the clubhead 1 shown in FIG. 11, so that the shaft case 5A is removed once from a hosel column 3. Then, the shaft case 5A is turned through 90°, 180° or 270°, whereby the position of the shaft 4 can be changed or shifted in parallel towards a heel portion, a back portion or a toe portion of the clubhead. The distance from the axis of the shaft to the center of gravity of the clubhead is changed by changing the position of the shaft 4 in the way described above. Additionally, the progression is changed by shifting the position of the shaft 4 towards the face side or the back portion of the clubhead.

The spline ring, the shaft case, the hosel column and the bolt are preferably made of a metal and are particularly preferably made of aluminum, titanium or an alloy thereof. A shaft case can be used which is made of an aluminum alloy and which is treated with an anodized aluminum so as to increase the degree of hardness at the surface thereof to thereby make the shaft case difficult to be scratched. However, the invention is not limited thereto. A hosel column can be used as the hosel column which is produced through machining using pure titanium as a material. However, the invention is not limited thereto. In one example of the invention, an inside diameter at an upper end of the hosel column 3 is about 10.5 mm, an inside diameter at a lower end thereof is about 8.5 mm, and a diameter of the threaded shank portion of the bolt 7 is in the range of 4 to 5 mm. However, the invention is not limited thereto.

Although no limitation is imposed on the material of the clubhead, in the case of a clubhead of a wood type, for example, a titanium alloy, an aluminum alloy or a stainless steel can be used for the clubhead. A titanium alloy having a small specific gravity is preferred as a titanium alloy for use for the surface of the face portion of the clubhead. For example, titanium alloys such as Ti-6Al-1Fe and Ti-6Al-2Fe are preferred. The specific gravities of these titanium alloys are of the order of 4.4. Titanium alloys having the specific gravity of 4.4 include those listed below.

Ti—8Al—1V—1Mo (specific gravity of 4.37)
Ti—7Al—2V (specific gravity of 4.35)
Ti—7.5Al—2V (specific gravity of 4.35)
Ti—8Al—1V (specific gravity of 4.34)
Ti—8Al—2V (specific gravity of 4.35)
Ti—8Al—1V—1Mo—0.15C (specific gravity of 4.37)
Ti—6Al—1Fe (specific gravity of 4.38)

As a grip which is attached to the shaft 4, a grip may be used which has a non-round cross-sectional shape. For example, a grip may be used which has a cross-sectional shape in which a lower side of an outer circumferential surface of the grip which is directed towards the ground when the golf club is at address protrudes further than other sides of the outer circumferential surface of the grip. In this case, there may be a situation in which the protruding portion of the grip is not positioned to face the ground when the orientation of the shaft case 5, 5A is changed. Then, in this invention, it is preferable to use a grip having a round cross-sectional shape.

Although the invention is described as being applied to the wood type clubhead, the invention can also be applied to a clubhead of a utility type which is similar to the wood type.

Next, a method for producing the clubhead of the golf club will be described.

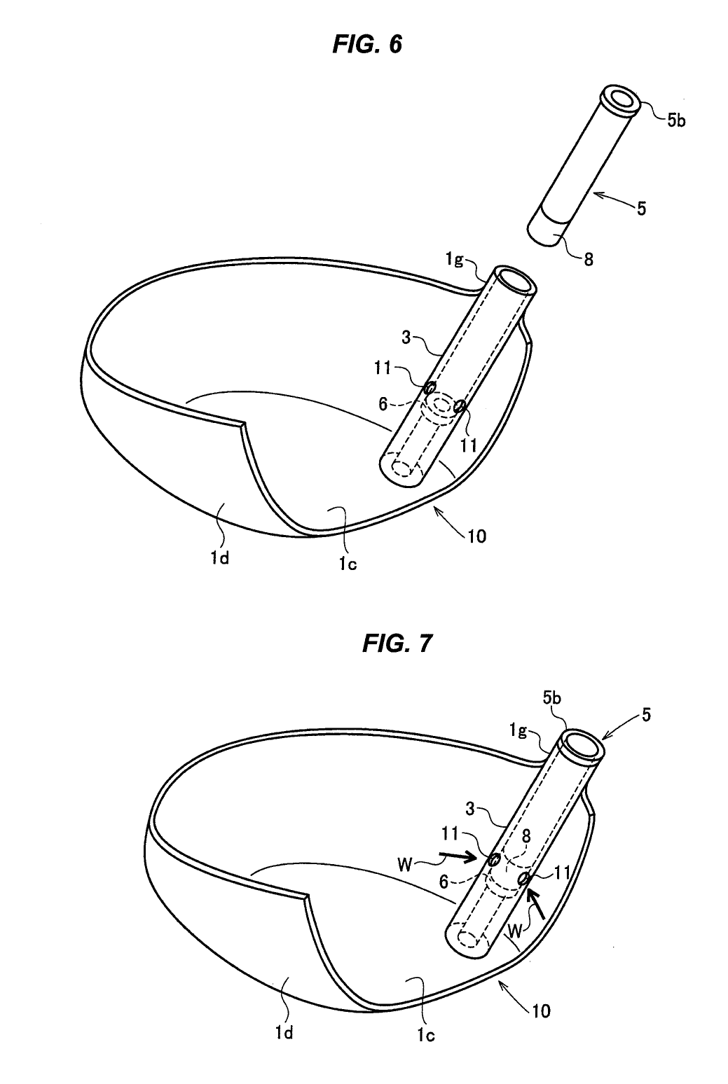

In this production method, as shown in FIGS. 6, 10, a clubhead main body 10 is used which is opened at the crown portion and the face portion. As shown in FIG. 10, the hosel column 3 is integrated into the clubhead main body 10 by welding. A hole or a plurality of holes 11 are provided in the hosel column 3 at a portion which lies upwards of the partition plate portion 6. The holes 11 penetrate the hosel column 3 from an inner circumferential surface to an outer circumferential surface thereof. In this embodiment, as the holes 11, there are provided a hole 11 which is oriented towards the face portion and holes 11 which are oriented towards the toe portion to the back portion of the clubhead.

The spline ring 8 is mounted at the distal end of the shaft case 5, and the splines of the shaft case 5 and the spline ring 8 are brought into engagement with each other. Then, the shaft case 5 to which the spline ring 8 is attached is inserted into the hosel column 3, and the spline ring 8 is brought into abutment with the partition plate portion 6 as shown in FIG. 7. The holes 11 face the outer circumferential surface of the spline ring 8 in this state.

Next, the orientation (the circumferential phase) of the shaft case 5 is adjusted so that the mark “N” provided on the flange 5b of the shaft case 5 is oriented towards the toe portion of the clubhead 1. Thereafter, welding work is performed through the holes 11 so that the hosel column 3 and the spline ring 8 are welded together. A TIG (tungsten insert gas) welding machine is used for this welding work, and a method can be adopted in which both the hosel column 3 and the spline ring 8 are fused for welding them together. However, the invention is not limited thereto. Arrows W in FIG. 7 denote directions in which electrodes are caused to approach at the time of welding.

After the completion of welding, the shaft case 5 is removed from the hosel column 3. The spline ring 8 is left staying within the hosel column 3.

Thereafter, as shown in FIG. 10, a crown portion 10b and a face portion 1a are welded to the crown portion and the face portion of the clubhead main body 10, respectively, as closure plates, and following this, an front edge of the crown portion 1b and an upper edge of the face portion 1a are welded together. Then, a finishing treatment such as deburring and painting is applied to the clubhead main body 10. By so doing, the golf club 1 is obtained in which the spline ring 8 is welded to the deep portion of the hosel column 3.

A plate into which the crown portion 1b and the face portion 1a are integrated continuously may be welded to the clubhead main body 10. In addition, a part or the whole of the crown portion may be formed from CFRP (carbon fiber reinforced plastics).

In FIGS. 6, 7, although the clubhead main body 10 is used in which the crown portion and the face portion are opened, a clubhead main body may be used in which a face portion, a sole portion and part of a heel end side portion are opened. When a hole 11 is provided only in the side facing the face portion, a clubhead main body may be used in which only the face portion is opened. However, it is preferable that a plurality of holes 11 are provided circumferentially at intervals so that welding is performed at a plurality of circumferential locations because the fixing strength of the spline ring 8 is increased thereby.

In FIGS. 6, 7, although the spline ring 8 is held by the shaft case 5, a jig may be used which has a distal end portion of the same shape as that of the shaft case 5. It is preferable that this jig is longer than the shaft case 5 and has a similar mark to the mark N.

What is claimed is:

1. A golf club comprising:
a shaft;
a clubhead attached to a distal end of the shaft;
a shaft case having a substantially cylindrical shape and secured to the distal end of the shaft, the shaft case being inserted into a hosel column of the clubhead and being fixed in place in the hosel column, wherein:
a partition plate portion is provided within the hosel column;
a spline ring in which a spline is provided on an inner circumferential surface of an inner hole is interposed between a distal end portion of the shaft case and the partition plate portion;
the spline ring is welded to the shaft case;
a projecting shaft portion is provided at a distal end of the shaft case;
a spline is provided on an outer circumferential surface of the projecting shaft portion;
the projecting shaft portion is inserted into the inner hole of the spline ring;
the spline of the projecting shaft portion and the spline of the spline ring are in engagement with each other; and
a bolt which is inserted through a bolt passage hole provided in the partition plate portion from a sole side of the clubhead is screwed into the shaft case, whereby the shaft case is fixed in place in the hosel column.

2. The golf club according to claim 1, wherein
a female or internally threaded hole is provided in a distal end face of the projecting shaft portion, so that the bolt is screwed into the internally threaded hole.

3. The golf club according to claim 1, wherein
an axis of the shaft is inclined relative to an axis of the cylindrical portion.

4. The golf club according to claim 1, wherein
an axis of the shaft and an axis of the cylindrical portion are parallel to each other.

5. A method for adjusting characteristics of a golf club comprising: a shaft; a clubhead attached to a distal end of the shaft; a shaft case having a substantially cylindrical shape and secured to the distal end of the shaft, the shaft case being inserted into a hosel column of the clubhead and being fixed in place in the hosel column, wherein: a partition plate portion is provided within the hosel column; a spline ring in which a spline is provided on an inner circumferential surface of an inner hole is interposed between a distal end portion of the shaft case and the partition plate portion; the spline ring is welded to the shaft case; a projecting shaft portion is provided at a distal end of the shaft case; a spline is provided on an outer circumferential surface of the projecting shaft portion; the projecting shaft portion is inserted into the inner hole of the spline ring; the spline of the projecting shaft portion and the spline of the spline ring are in engagement with each other; and a bolt which is inserted through a bolt passage hole provided in the partition plate portion from a sole side of the clubhead is screwed into the shaft case, whereby the shaft case is fixed in place in the hosel column, the method comprising:
removing the bolt so as to separate the projecting shaft portion of the shaft case from the spline ring;
rotating the shaft case so as to change the position of the shaft passage hole or the inclination of the shaft; and
bringing the projecting shaft portion of the shaft case into engagement with the spline ring again, and fixing the shaft case with the bolt.

6. A method for adjusting characteristics of a golf club comprising: a shaft; a clubhead attached to a distal end of the shaft; a shaft case having a substantially cylindrical shape and secured to the distal end of the shaft, the shaft case being inserted into a hosel column of the clubhead and being fixed in place in the hosel column, wherein: a partition plate portion is provided within the hosel column; a spline ring in which a spline is provided on an inner circumferential surface of an inner hole is interposed between a distal end portion of the shaft case and the partition plate portion; the spline ring is welded to the shaft case; a projecting shaft portion is provided at a distal end of the shaft case; a spline is provided on an outer circumferential surface of the projecting shaft portion; the projecting shaft portion is inserted into the inner hole of the spline ring; the spline of the projecting shaft portion and the spline of the spline ring are in engagement with each other; and a bolt which is inserted through a bolt passage hole provided in the partition plate portion from a sole side of the clubhead is screwed into the shaft case, whereby the shaft case is fixed in place in the hosel column, the method comprising:
preparing a different shaft case and shaft assembly in advance by securing a different shaft to a different shaft case;
removing a shaft case and shaft assembly mounted in the golf club from the clubhead; and
mounting the different shaft case and shaft assembly so prepared in the clubhead.

7. A method for producing a golf club comprising: a shaft; a clubhead attached to a distal end of the shaft; a shaft case having a substantially cylindrical shape and secured to the distal end of the shaft, the shaft case being inserted into a hosel column of the clubhead and being fixed in place in the hosel column, wherein: a partition plate portion is provided within the hosel column; a spline ring in which a spline is provided on an inner circumferential surface of an inner hole is interposed between a distal end portion of the shaft case and the partition plate portion; the spline ring is welded to the shaft case; a projecting shaft portion is provided at a distal end of the shaft case; a spline is provided on an outer circumferential surface of the projecting shaft portion; the projecting shaft portion is inserted into the inner hole of the spline ring; the spline of the projecting shaft portion and the spline of the spline ring are in engagement with each other; and a bolt which is inserted through a bolt passage hole provided in the partition plate portion from a sole side of the clubhead is screwed into the shaft case, whereby the shaft case is fixed in place in the hosel column, the method comprising:
providing a hole in a side circumferential surface of the hosel column;
holding the spline ring at the distal end of the shaft case;
inserting the spline ring and the shaft case within the hosel column;
welding the spline ring and the hosel column together via the hole; and
removing the shaft case from the hosel column.

8. The method according to claim 7, further comprising
making up the clubhead from a clubhead main body having the hosel column and an open portion which facilitates welding work and a closure part which closes the open portion, and integrating the closure part into the clubhead main body after the welding work of the spline ring.

9. The method according to claim 8, wherein:
a plurality of holes like the hole are provided; and
open portions like the open portion are present in a crown portion and a face portion of the clubhead of the golf club.

10. A method for producing a golf club a golf club comprising: a shaft; a clubhead attached to a distal end of the shaft; a shaft case having a substantially cylindrical shape and secured to the distal end of the shaft, the shaft case being inserted into a hosel column of the clubhead and being fixed in place in the hosel column, wherein: a partition plate portion is provided within the hosel column; a spline ring in which a spline is provided on an inner circumferential surface of an inner hole is interposed between a distal end portion of the shaft case and the partition plate portion; the spline ring is welded to the shaft case; a projecting shaft portion is provided at a distal end of the shaft case; a spline is provided on an outer circumferential surface of the projecting shaft portion; the projecting shaft portion is inserted into the inner hole of the spline ring; the spline of the projecting shaft portion and the spline of the spline ring are in engagement with each other; and a bolt which is inserted through a bolt passage hole provided in the partition plate portion from a sole side of the clubhead is screwed into the shaft case, whereby the shaft case is fixed in place in the hosel column, the method comprising:
providing a hole in a side circumferential surface of the hosel column;
holding the spline ring at a distal end portion of a jig which is of the same shape as the shaft case;
inserting the spline ring and the jig within the hosel column;
welding the spline ring and the hosel column together via the hole; and
removing the jig from the hosel column.

11. The method according to claim 10, further comprising
making up the clubhead from a clubhead main body having the hosel column and an open portion which facilitates welding work and a closure part which closes the open portion, and integrating the closure part into the clubhead main body after the welding work of the spline ring.

12. The method according to claim 11, wherein:
a plurality of holes like the hole are provided; and
open portions like the open portion are present in a crown portion and a face portion of the clubhead of the golf club.
